(19) United States
(12) Patent Application Publication
(10) Pub. No.: US 2015/0185842 A1
(43) Pub. Date: Jul. 2, 2015

(54) HAPTIC FEEDBACK FOR THIN USER INTERFACES

(71) Applicant: Microsoft Corporation, Redmond, WA (US)

(72) Inventors: Carl Edward Picciotto, Clyde Hill, WA (US); Gahn Gavyn Yun, Bellevue, WA (US); Launnie Keith Eris Ginn, Kent, WA (US); Ronald John Newton, Redmond, WA (US)

(73) Assignee: Microsoft Corporation, Redmond, WA (US)

(21) Appl. No.: 14/144,876

(22) Filed: Dec. 31, 2013

(51) Int. Cl. G06F 3/01

(52) U.S. Cl. CPC G06F 3/016

(57) ABSTRACT

Piezo-actuated structures are disclosed and haptic-enabled devices employing piezo-actuated structures are disclosed. One embodiment of a piezo-actuated structure comprises a non-traveling deformable layer, a backer structure that partitions the deformable layer into a set of substantially isolated haptic regions, a set of user sensors that are capable of detecting user interactions with at least one of the substantially isolated haptic regions. In another embodiment, a haptic-enabled device comprises a touch sensitive surface that comprises a deformable layer and set of substantially isolated haptic regions. The haptic-enabled device is capable of sending control signals to the isolated haptic region with which the user is interacting. The set of substantially isolated haptic regions may affect a number of special haptic experiences for the user of the device. Such special haptic experiences comprise a single hand (left and/or right) haptic event, a single user finger haptic event.

### BACKGROUND

As consumer devices get thinner and thinner to satisfy industrial design and usability goals, traditional mechanical user input devices such as moveable keys and dome switches are being displaced by superflat devices. Such superflat devices may employ different technologies, e.g., such as capacitive sensors and force-sensitive technologies such as FSR's (force-sensitive resistors) and piezoelectric or piezoresistive force sensors. One example may include superflat Touch Cover keyboards. These devices typically feature keys and buttons that provide little or no tactile feedback, either passive (e.g. texture or fixed relief) or active (responding to user activation). The result tends to be a compromised user experience: keys and buttons that provide little or no tactile feedback to the user, thereby reducing user confidence, efficiency, and delight.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Piezo-actuated structures are disclosed and haptic-enabled devices employing piezo-actuated structures are disclosed. One embodiment of a piezo-actuated structure comprises a non-traveling deformable layer, a backer structure that partitions the deformable layer into a set of substantially isolated haptic regions, a set of user sensors that are capable of detecting user interactions with at least one of the substantially isolated haptic regions. In another embodiment, a haptic-enabled device comprises a touch sensitive surface that comprises a deformable layer and set of substantially isolated haptic regions. The haptic-enabled device is capable of sending control signals to the isolated haptic region with which the user is interacting. The set of substantially isolated haptic regions may affect a number of special haptic experiences for the user of the device. Such special haptic experiences comprise a single hand (left and/or right) haptic event, a single user finger haptic event. In addition, a haptic experience/event/response may comprise a combination of vibro-tactile sensations and audio sensations.

In one embodiment, a piezo-actuated structure is disclosed, said structure comprising: a non-traveling deformable layer; a piezo layer, said piezo layer mechanically mated to said deformable layer; a backer structure, said backer structure mechanically mated to said deformable layer and further wherein said a set of user sensors; and further wherein said piezo layer is capable of transmitting a haptic response to said deformable layer in response to a user interaction sensed by said set of user sensors.

In another embodiment, a method for actuating a piezo-actuated structure, said piezo-actuated structure comprising a non-traveling deformable layer, a backer structure mated to said deformable layer and forming a set of substantially isolated haptic regions upon said deformable layer, a set of piezo elements mated to said deformable layer and placed within said set of substantially isolated haptic regions, a set of user sensors and controller for receiving signals from said set of user sensors and sending control signals to said set of piezo elements in response to said signals, the method comprising: receiving a first signal from said set of user sensors in response to a user interaction; determining which isolated haptic region said user is interacting; and sending an actuation signal to at least one piezo element within said isolated haptic region said user is interacting.

In yet another embodiment, A haptic-enabled device comprising: a touch sensitive surface, said touch sensitive surface further comprising a deformable layer; a backer structure, said backer structure partitioning said deformable layer into a set of isolated haptic regions; a set of piezo elements, said set of piezo elements in mechanical communication with said deformable layer and placed with said set of isolated haptic regions; a set of user sensors, said set of user sensors capable of sensing a user interaction with said touch sensitive surface; a controller, said controller capable of receiving signals from said set of user sensors and sending control signals in response to receiving signals from said set of user sensors; and a piezo actuating circuit, said piezo actuating circuit capable of receiving control signals from said controller and sending piezo-actuating signals to said set of piezo elements.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is one embodiment of an exemplary device comprising piezo-actuated structures as made in accordance with the principles of the present application.

FIGS. 2 and 3 depict an exemplary keyboard for the device as shown in FIG. 1.

FIG. 4 depicts a cross-sectional view of one embodiment of a haptic enabled device and a suitable piezo structure as made in accordance with the principles of the present application.

FIGS. 5A and 5B show a cross-sectional view of a piezo structure mated to the thin deformable surface, in a rest and an actuated state, respectively.

FIGS. 6A, 6B and 6C depict one embodiments of a set of piezo discs as mated to the underside of a PCB board and one potential manner of mating such piezo discs, respectively.

FIG. 7 depicts a cross-sectional view of the layers of one exemplary haptic enabled device, as made in accordance with the principles of the present application.

FIG. 8 is one embodiment of a haptic enabled device comprising a set of piezo discs affixed to a backing structure.

FIGS. 9A, 9B and 9C depict several possible waveforms embodiments that may tend to produce a desired haptic experience to a user of a device as made in accordance with the principles of the present application.

FIG. 10 is one schematic diagram of a haptic-enable device and its circuitry as made in accordance with the principles of the present application.

FIG. 11. Is one embodiment of a circuit that may tend to affect the waveforms of FIGS. 9A, 9B and 9C.

FIG. 12 is one embodiment of a piezo driving circuit for a suitable piezo structure as made in accordance with the principles of the present application.

FIG. 13 is one embodiment of one embodiment of a piezo controller in communication with a piezo drive circuit and piezo element.

FIGS. 14A, 14B and 14C are alternative piezo structures that may be suitable for the systems and techniques of the present application.

FIGS. 15A and 15B are two exemplary embodiments of a haptic enable device that is partitioned into haptic regions that are substantially isolated one from the other.

### DETAILED DESCRIPTION

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

### INTRODUCTION

Haptic feedback in general has been employed in a number of different platforms—e.g., mobile devices, smart phones and the like. Electromagnetic motors/rumblers—e.g., Eccentric Rotating Mass vibration motors (ERMs) and Linear Resonant Actuator vibration motors (LRAs)—are well known, providing full-body vibrations for certain devices (e.g. pager and cellphone vibrators) or occasionally more localized vibrations (e.g. Microsoft's Arc Touch Mouse, Explorer Touch Mouse, Sculpt Touch Mouse). Piezo LRA's are also known to the art, but these devices have only been used to provide full-body vibrations, albeit sharper in feeling than those provided by electromagnetic devices.

In many embodiments of the present application, there are described several form-factors architectures (e.g., super flat) and/or the sharp button-like feeling with such form-factor architectures. In many other embodiments, these form-factor architectures may be employed in many different fields of use—e.g., in keyboards, or to provide tactile feedback to the keys and to the pressure-sensing virtual buttons in the trackpad. Such keyboards and/or trackpads may be of the “non-traveling” type. In this context, “non-travel” means the touch surface does not move appreciably to actuate a mechanical switch.

In many embodiments, there are disclosed various applications such as: keyclick tactile feedback (haptics) in flat non-travel keyboards and non-travel trackpads and similar user interfaces. Many such embodiments comprise a set of flat piezo discs that may be mounted directly to the underside of touch sensor PCB or onto backer structures, to effect vibrations by directly warping the PCB or the backer structures, respectively. In other embodiments, these flat piezo discs may be oriented to vibrate the PCB as a plate or collection of plates. In other embodiments, there are disclosed a set of piezo structure drive waveform descriptions and example circuit topologies for implementation that affect a desired haptic user experience. Suitable piezo materials may comprise piezoceramic material, PZT, electroactive polymers and electromechanical polymers or the like.

One Exemplary Environment

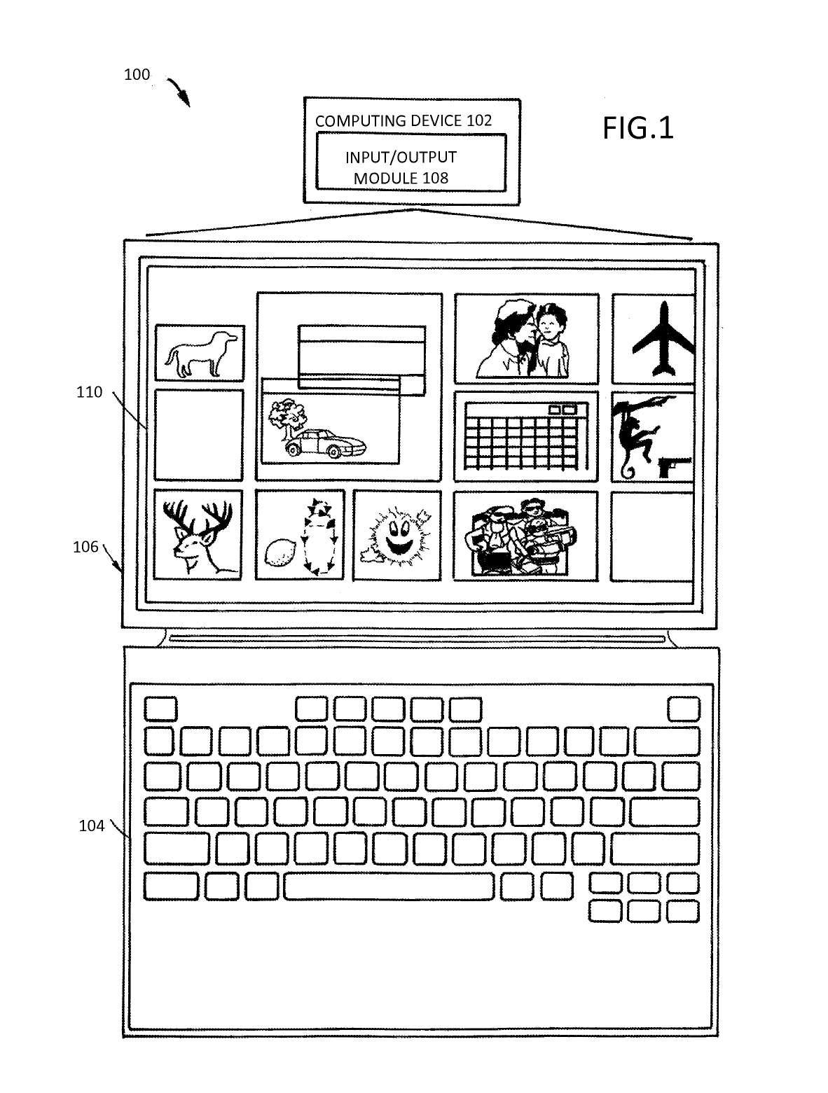

To appreciate the applicability of the various techniques of the present application, attention will now be drawn to one exemplary environment in which these techniques and use of the haptic embodiments described herein may reside. FIG. 1 is an illustration of an environment 100 in an example implementation that is operable to employ the techniques described herein. The illustrated environment 100 includes an example of a computing device 102 that is physically and communicatively coupled to an input device 104 via a flexible hinge 106. The computing device 102 may be configured in a variety of ways. For example, the computing device 102 may be configured for mobile use, such as a mobile phone, a tablet computer as illustrated, and so on that is configured to be held by one or more hands of a user. Thus, the computing device 102 may range from full resource devices with substantial memory and processor resources to a low-resource device with limited memory and/or processing resources. The computing device 102 may also relate to software that causes the computing device 102 to perform one or more operations.

The computing device 102, for instance, is illustrated as including an input/output module 108. The input/output module 108 is representative of functionality relating to processing of inputs and rendering outputs of the computing device 102. A variety of different inputs may be processed by the input/output module 108, such as inputs relating to functions that correspond to keys of the input device 104, keys of a virtual keyboard displayed by the display device 110 to identify gestures and cause operations to be performed that correspond to the gestures that may be recognized through the input device 104 and/or touchscreen functionality of the display device 110, and so forth. Thus, the input/output module 108 may support a variety of different input techniques by recognizing and leveraging a division between types of inputs including key presses, gestures, and so on.

In the illustrated example, the input device 104 is configured as having an input portion that includes a keyboard having a QWERTY arrangement of keys and track pad although other arrangements of keys are also contemplated. Further, other non-conventional configurations are also contemplated, such as a game controller, configuration to mimic a musical instrument, and so forth. Thus, the input device 104 and keys incorporated by the input device 104 may assume a variety of different configurations to support a variety of different functionality.

As previously described, the input device 104 is physically and communicatively coupled to the computing device 102 in this example through use of a flexible hinge 106. The flexible hinge 106 is flexible in that rotational movement supported by the hinge is achieved through flexing (e.g., bending) of the material forming the hinge as opposed to mechanical rotation as supported by a pin, although that embodiment is also contemplated. Further, this flexible rotation may be configured to support movement in one or more directions (e.g., vertically in the figure) yet restrict movement in other directions, such as lateral movement of the input device 104 in relation to the computing device 102. This may be used to support consistent alignment of the input device 104 in relation to the computing device 102, such as to align sensors used to change power states, application states, and so on.

The flexible hinge 106, for instance, may be formed using one or more layers of fabric and include conductors formed as flexible traces to communicatively couple the input device 104 to the computing device 102 and vice versa. This communication, for instance, may be used to communicate a result of a key press to the computing device 102, receive power from the computing device, perform authentication, provide supplemental power to the computing device 102, and so on.

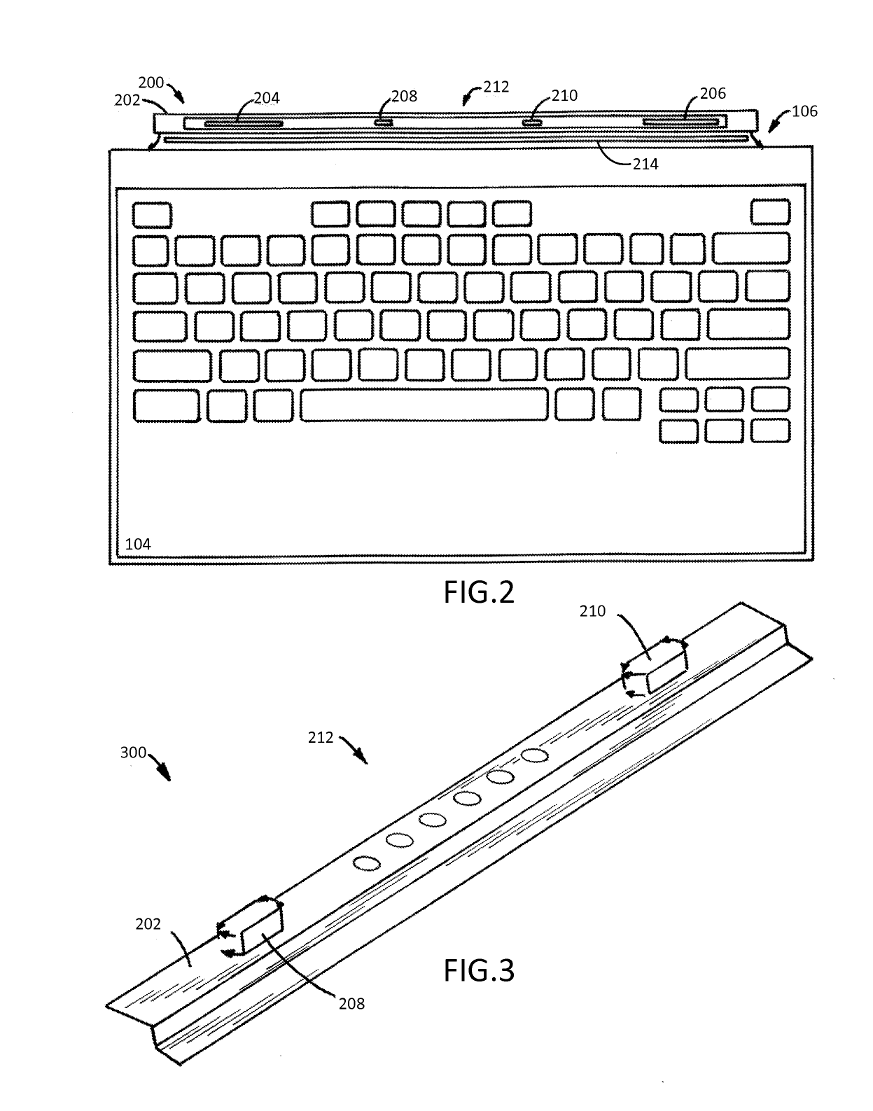

FIG. 2 depicts an example implementation 200 of the input device 104 of FIG. 1 as showing the flexible hinge 106 in greater detail. In this example, a connection portion 202 of the input device is shown that is configured to provide a communicative and physical connection between the input device 104 and the computing device 102. The connection portion 202 as illustrated has a height and cross section configured to be received in a channel in the housing of the computing device 102, although this arrangement may also be reversed without departing from the spirit and scope thereof.

The connection portion 202 is flexibly connected to a portion of the input device 104 that includes the keys through use of the flexible hinge 106. Thus, when the connection portion 202 is physically connected to the computing device 102 the combination of the connection portion 202 and the flexible hinge 106 supports movement of the input device 104 in relation to the computing device 102 that is similar to a hinge of a book.

Through this rotational movement, a variety of different orientations of the input device 104 in relation to the computing device 102 may be supported. For example, rotational movement may be supported by the flexible hinge 106 such that the input device 104 may be placed against the display device 110 of the computing device 102 and thereby act as a cover. Thus, the input device 104 may act to protect the display device 110 of the computing device 102 from harm.

The connection portion 202 may be secured to the computing device in a variety of ways, an example of which is illustrated as including magnetic coupling devices 204, 206 (e.g., flux fountains), mechanical coupling protrusions 208, 210, and a plurality of communication contacts 212. The magnetic coupling devices 204, 206 are configured to magnetically couple to complementary magnetic coupling devices of the computing device 102 through use of one or more magnets. In this way, the input device 104 may be physically secured to the computing device 102 through use of magnetic attraction.

The connection portion 202 also includes mechanical coupling protrusions 208, 210 to form a mechanical physical connection between the input device 104 and the computing device 102. The mechanical coupling protrusions 208, 210 are shown in greater detail in relation to FIG. 3, which is discussed below.

FIG. 3 depicts an example implementation 300 showing a perspective view of the connection portion 202 of FIG. 2 that includes the mechanical coupling protrusions 208, 210 and the plurality of communication contacts 212. As illustrated, the mechanical coupling protrusions 208, 210 are configured to extend away from a surface of the connection portion 202, which in this case is perpendicular although other angles are also contemplated.

The mechanical coupling protrusions 208, 210 are configured to be received within complimentary cavities within the channel of the computing device 102. When so received, the mechanical coupling protrusions 208, 210 promote a mechanical binding between the devices when forces are applied that are not aligned with an axis that is defined as correspond to the height of the protrusions and the depth of the cavity.

The connection portion 202 is also illustrated as including a plurality of communication contacts 212. The plurality of communication contacts 212 is configured to contact corresponding communication contacts of the computing device 102 to form a communicative coupling between the devices as shown. The connection portion 202 may be configured in a variety of other ways, including use of a rotational hinge, mechanical securing device, and so on. In the following, an example of a docking apparatus is described and shown in a corresponding figure.

It will be appreciated that—while FIGS. 1 through 3 represent one possible environment for these haptic techniques, these techniques find application in other environments and the scope of the present application should not be limited to this exemplary environment.

Embodiments Employing Piezo Discs

In many of the embodiments of the present application, there are employed a set of piezo discs (e.g., audio discs) that may vibrate touch surfaces. Such vibrations may be used to create a “click” sensation in response to a user's interaction. Such user's interactions may be sensed with one or several user sensors utilizing any means and/or technologies available—e.g., capacitive sensing, or through pressure sensing. In the case of pressure sensing, the haptic feedback may give a realistic button feeling, as it may interact with the user via pressure.

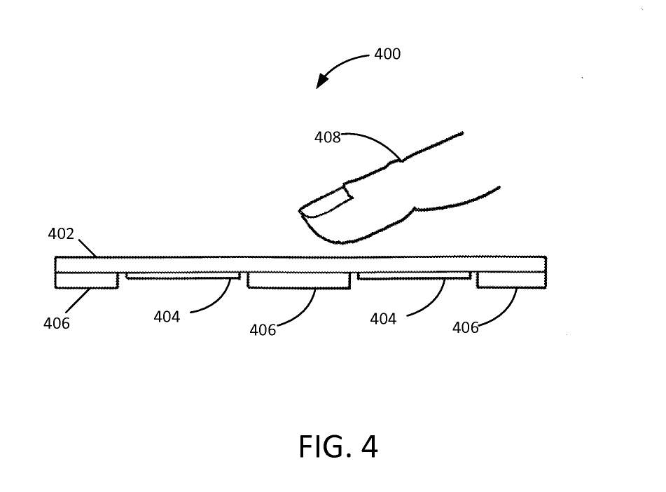

FIG. 4 shows a cross-sectional view 400 of an exemplary touch-sensitive surface Printed Circuit Board (PCB) 402. In one embodiment, PCB surface 402 may comprise a set of piezo elements 404 mated (or otherwise attached) to PCB 402 that deliver a haptic and/or click sensation to a user's finger 408. As will be described further herein, the set of piezo elements 404 may be placed upon the surface 402 in any pattern possible. The surface may optionally comprise a set of backer structures 406—e.g., placed between piezo elements 404—to provide a degree of isolation of haptic sensations for the user. As described further herein, such isolation may provide a desirable user experience—e.g., if the surface is functionally a keyboard and the user expects to feel haptic feedback to substantially emulate a mechanical keyboard.

In another embodiment, a Printed Circuit Board Assembly (PCBA) may additionally comprise a set of sense elements of a touch interface—e.g., capacitive sensing (capsense) electrodes or the PCB traces of a pressure sensing system. To provide haptic feedback, piezo discs may be affixed to the underside of the PCB in any possible manner, e.g., either soldered or glued or the like. The piezo elements may comprise piezo discs, such as used for audio discs. Such piezo discs may be free of the metal backing typical of audio piezo construction. By comparison, free-standing audio discs typically require a metal backing to translate lateral strains in the piezo to diaphragm movement. However, in many embodiments of the present application, it is possible to use the lateral rigidity of the PCB material to provide the strain required to effect this translation.

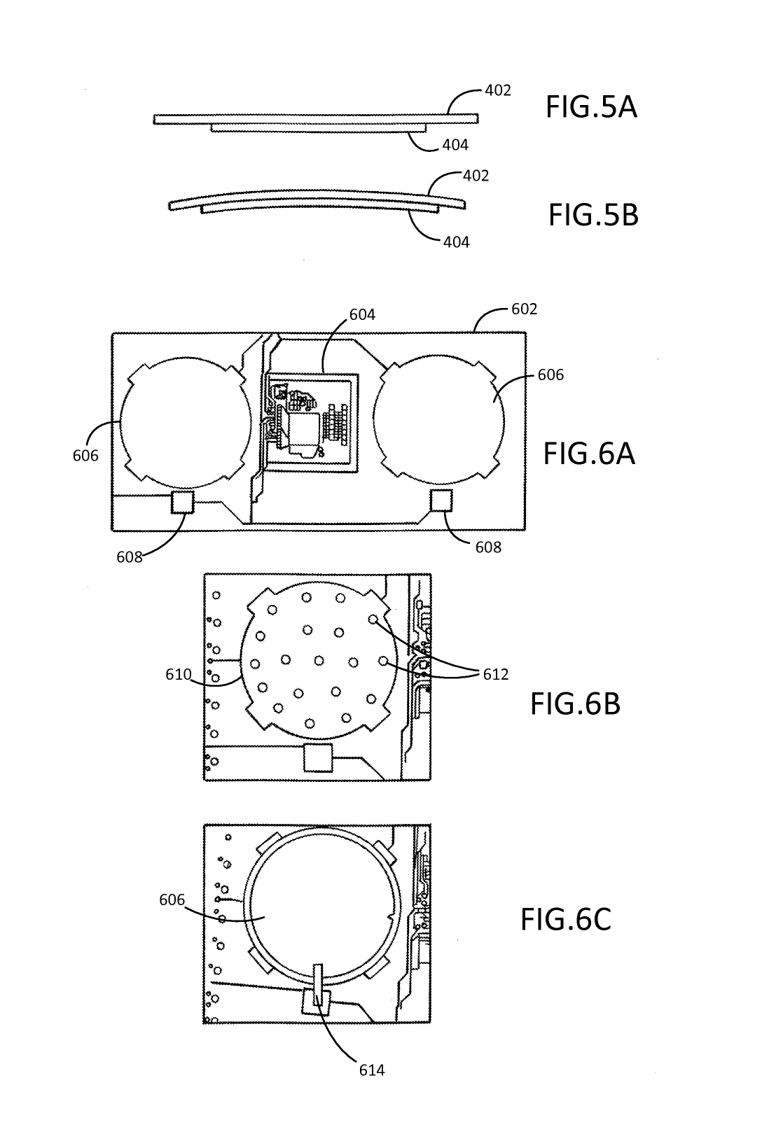

FIGS. 5A and 5B depict a PCB surface 402 and piezo elements/structures 404 where the piezo structure is initially not actuated and then actuated, respectively. At rest (as in FIG. 5A), the assembly is substantially flat. However, as in FIG. 5B, when the piezo element is energized with an applied voltage, the piezo element contracts and the lateral rigidity of the PCB causes the assembly to bend at the center like a diaphragm. Such bending (or otherwise warping, displacement and/or deformation) of the PCB surface may be sufficient for a user to feel such motion—as is desired for a haptic experience.

In different embodiments, it may be possible to vary the thickness of the PCB. For certain embodiments, thinner boards may flex more but may tend to produce a more localized vibration. In other embodiments, thicker boards may flex less but spread the vibration over a larger area. In many embodiments, 0.2 mm-1.0 mm may suffice as a typical range of effective PCB thicknesses.

As will be disclosed further herein, when certain waveforms are applied to the piezo structures, the haptic experience may be made to emulate a mechanical “click” feeling, as may be produced by the mechanical action of a keystroke of a physical keyboard.

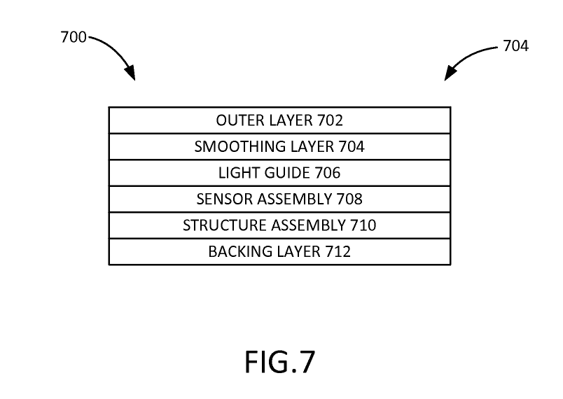

FIG. 6A depicts one embodiment of a PCBA 602 that comprises a pair of piezo discs 606 affixed to the underside of the PCBA. PCBA 602 may further comprise electronic circuitry 604 may be capable of providing energizing signals to the piezo discs 606 (via conducting pads 608) in response to sensed conditions. FIG. 6B depicts one manner of affixing a piezo disc to PCBA. As may be seen, solder paste 612 may be applied to the mounting pad 610 of the PCBA. In FIG. 6C, piezo disc 606 may be placed on top of the mounting pad 610 and a desired heat may be applied in order to induce the solder past to flow and, thereby, mated the piezo disc to the PCBA. Thereafter, a conduction bar 614 may be affixed to the piezo disc and the conducting pad 608 in order to effect an electrical connection of the piezo disc to the circuitry 604.

Backer Board Embodiments

As an alternative embodiment to affixing piezo structures onto a PCBA, it may be possible to affix such piezo structures onto the backing structures of various components—e.g., keyboards or the like.

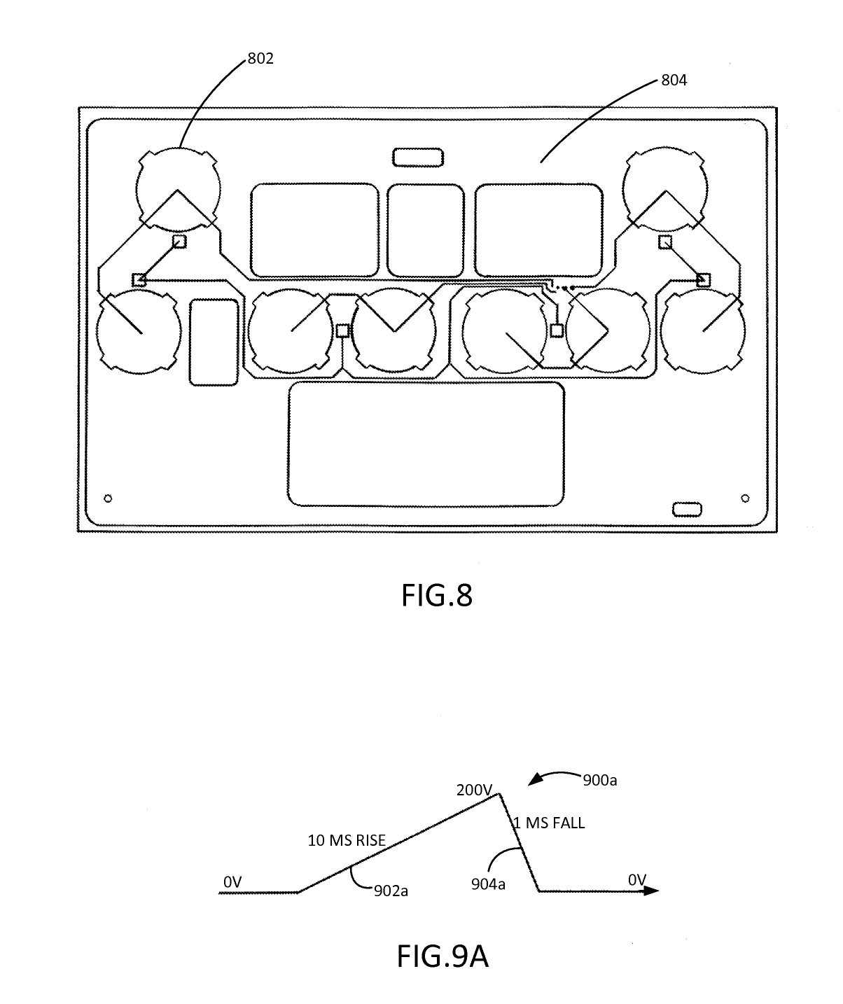

FIG. 7 depicts an example implementation 700 showing a cross section of keyboard 104 of FIG. 1. The outer layer 702 is configured to supply an outer surface of the input device 104 with which a user may touch and interact. The outer layer 702 may be formed in a variety of ways, such as from a fabric material, e.g., a backlight compatible polyurethane with a heat emboss for key formation, use of a laser to form indications of inputs, and so on.

Beneath the outer layer is a smoothing layer 704. The smoothing layer 704 may be configured to support a variety of different functionality. This may include use as a support to reduce wrinkling of the outer layer 702, such as through formation as a thin plastic sheet, e.g., approximately 0.125 millimeters of polyethylene terephthalate (PET), to which the outer layer 702 is secured through use of an adhesive. The smoothing layer 704 may also be configured to including masking functionality to reduce and even eliminate unwanted light transmission, e.g., “bleeding” of light through the smoothing layer 704 and through a fabric outer layer 702. The smoothing layer also provides a continuous surface under the outer layer, such that it hides any discontinuities or transitions between the inner layers.

A light guide 706 is also illustrated, which may be included as part of a backlight mechanism to support backlighting of indications (e.g., legends) of inputs of the input device 104. This may include illumination of keys of a keyboard, game controls, gesture indications, and so on. The light guide 706 may be formed in a variety of ways, such as from a 250 micron thick sheet of a plastic, e.g., a clear polycarbonate material with etched texturing. Additional discussion of the light guide 706 may be found beginning in relation to FIG. 5.

A sensor assembly 708 is also depicted. Thus, as illustrated the light guide 706 and the smoothing layer 704 are disposed between the outer layer 702 and the sensor assembly 708. The sensor assembly 708 is configured detect proximity of an object to initiate an input. The detected input may then be communicated to the computing device 102 (e.g., via the connection portion 202) to initiate one or more operations of the computing device 102. The sensor assembly 708 may be configured in a variety of ways to detect proximity of inputs, such as a capacitive sensor array, a plurality of pressure sensitive sensor nodes (e.g., membrane switches using a force sensitive ink), mechanical switches, a combination thereof, and so on.

A structure assembly 710 is also illustrated. The structure assembly 710 may be configured in a variety of ways, such as a trace board and backer that are configured to provide rigidity to the input device 104, e.g., resistance to bending and flexing. A backing layer 712 is also illustrated as providing a rear surface to the input device 104. The backing layer 712, for instance, may be formed from a fabric similar to an outer layer 702 that omits one or more sub-layers of the outer layer 702, e.g., a 0.38 millimeter thick fabric made of wet and dry layers of polyurethane. Although examples of layers have been described, it should be readily apparent that a variety of other implementations are also contemplated, including removal of one or more of the layers, addition of other layers (e.g., a dedicated force concentrator layer, mechanical switch layer), and so forth. Thus, the following discussion of examples of layers is not limited to incorporation of those layers in this example implementation 700 and vice versa.

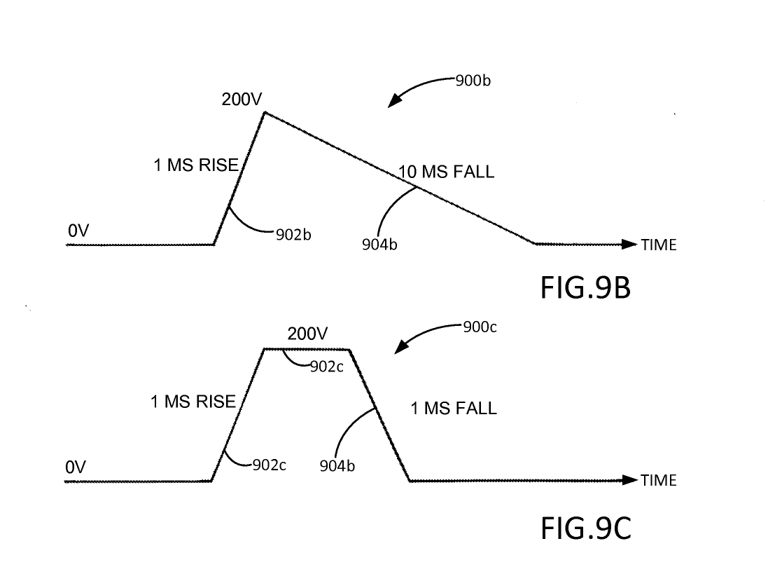

FIG. 8 depicts one embodiment in which piezo discs 802 (or otherwise piezo structures and/or elements) may be applied to the backer board 804, as opposed to being affixed to the underside of a PCBA. For the purposes of the present application, piezo structures may encompass discs, bars, strips or any other shape desired. Backer board 804 may, in turn, be applied to the underside of a PCBA. In many keyboard embodiments, piezo disc diameters may vary between 15 mm to 30 mm, according to desired haptic experiences. In addition, it will be appreciated that the placement and arrangement of the piezo discs/structures on either the PCBA or the backer board may vary according to desired haptic experiences afforded the users of the component.

Special Haptic Experience Embodiments

As previously mentioned, it may be desirable for a non-traveling user interface component (e.g., keyboard, trackpad or the like) to provide the user a special haptic experience—e.g., a click-like tactile feedback, as might be provided by a mechanical actuator and/or switch on a mechanical component, such as a mechanical keyboard, etc.

In order to affect the feeling of a sharp button click for the piezo-actuators, it may be possible to create such a feeling from a high velocity deflection of the piezo structure. Embodiment for creating that feeling may be affected by using a fast ramp for the piezo driving signals.

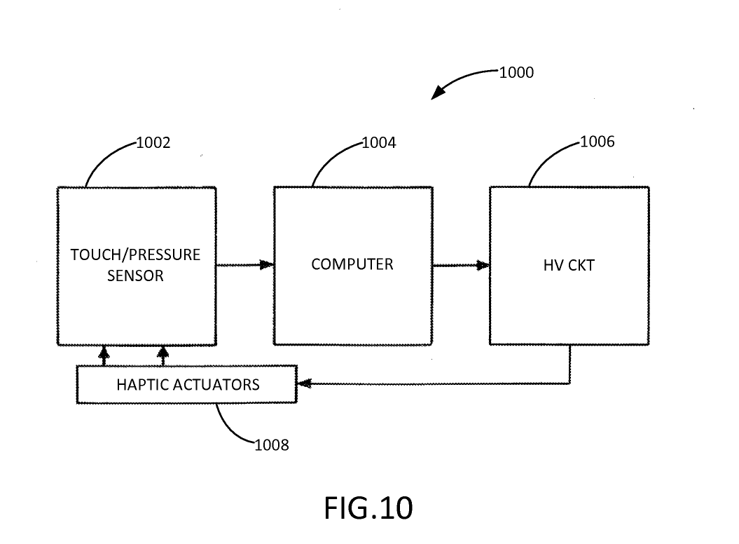

FIGS. 9A, 9B and 9C are three possible embodiments of such a driving signal for a suitable piezo structure. In FIG. 9A, a waveform 900a is depicted comprising two ramps for charging/energizing the piezo structure—a first, relatively slow (e.g., in the 5 ms to 10 ms range) velocity charging ramp 902a (up to a first charging level—e.g., substantially in the range of 200V), followed by a fast discharging ramp 904a (e.g., in the 0.5 ms to 1.5 ms range). In this embodiment, the click sensation tends to occur during the high-velocity portion of the waveform, 904a, at the end. A user's finger may tend to feel nothing (or have a much less sensation) during the charging ramp. As shown in FIG. 9A, exemplary figures are given—e.g., a 10 ms rising ramp up from 0V to 200V and a 1 ms falling ramp down from 200V to 0V. It will be appreciated that these figures are exemplary and that the scope of the present application should not be so limited to these figures.

Alternatively, in FIG. 9B, it is possible to have a waveform 900b that comprises a fast velocity (e.g., in the 0.5 ms to 1.5 ms range) charging/energizing ramp 902b (up to a first charging level—e.g., substantially in the range of 200V), followed by a slower decaying ramp 904b. With this type of driving signal to the piezo structure, a click sensation occurs during the high-velocity portion 902b of the waveform. During slower decaying portion 904b, the finger may tend to feel nothing or have a much less sensation. As with FIG. 9A above, non-limiting exemplary figures are also provided.

In FIG. 9C, a third waveform 900c comprises a first, fast (e.g., in the 0.5 ms to 1.5 ms range) ramp 902c, followed by a plateau 903c, and then a second, fast (e.g., in the 0.5 ms to 1.5 ms range) falling ramp 904c. Non-limited exemplary figures are also provided, similarly for FIGS. 9A and 9B.

In the embodiments of FIGS. 9B and 9C, waveforms 900b or 900c above represent waveforms that comprise a fast (e.g., 0.5-1.5 ms) positive-going transition, causing the touch surface to snap UP towards the user's finger, rather than DOWN. It has been observed that the sensation imparted to the finger with an UP waveform may tend to be a more direct, localized feeling—versus a more kinesthetic in-the-hand feeling created by DOWN waveforms. However, it should be appreciated that DOWN haptic sensations may be deemed sufficient in many applications.

Piezo-Actuating Circuit Embodiments

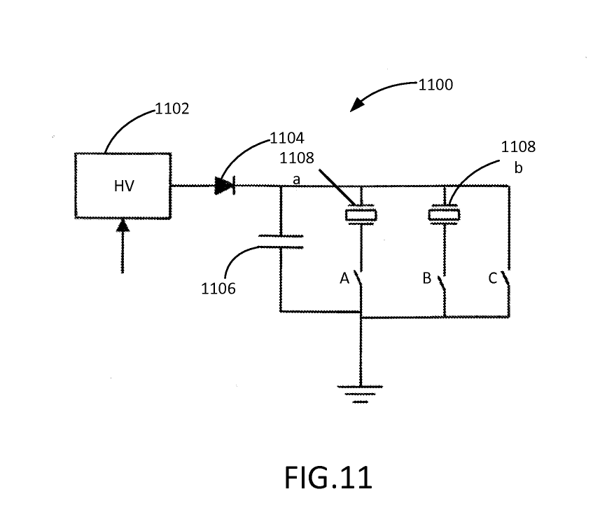

FIG. 10 is one exemplary embodiment of a smart and/or mobile device architecture 1000 that may use the systems and techniques of the present application. As shown, system 1000 comprises a set of touch and/or pressure sensors 1002. Sensors 1002 feed signals that are capable of detecting user interaction with the system 1000 and input them into a processor and/or computer 1004. Computer 1004 may further comprise computer readable storage upon which there may be stored computer readable instructions that, when read by a processor, may cause the computer and/or processor to send control signals to the HV circuit 1006. HV circuit 1006 may, in turn, generate the various waveforms that drive the haptic actuators 1008 (e.g., the piezo discs, structures and/or elements that are described herein).

It will be appreciated that there may be other architectures that may take benefit of the systems and techniques of the present application, and that the scope of the present application is not limited to this exemplary architecture.

However the system employing the haptic actuators may be architected (e.g., as in FIG. 10 or otherwise), it may still be desirable to have additional circuitry to affect suitable control over the piezo elements and have them react in a proper manner in response to the various waveforms discussed.

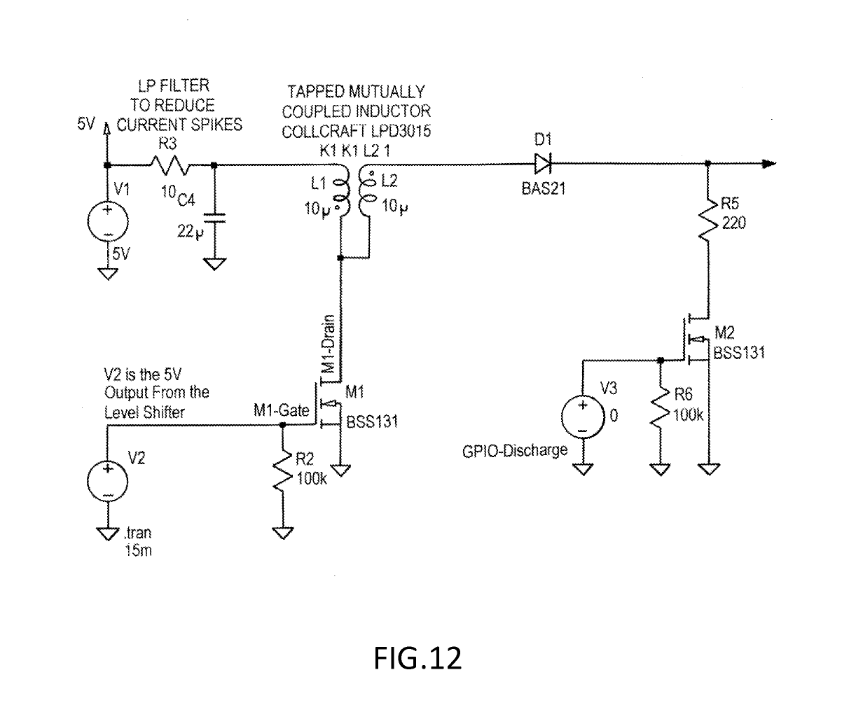

For merely one example, FIG. 11 depicts one possible embodiment of a circuit 1100 that may affect a suitable response to the waveforms of FIGS. 9A, 9B and 9C.

In the cases of a fast UP waveforms of FIGS. 9B and 9C, an UP waveform driving circuit may require large in-rushes of current, and may therefore be impractical to implement in battery-operated devices or in devices with connectors with limited current capacity. In the embodiment of FIG. 11, circuit 1100 may comprise at least one capacitor 1106 that may be charged slowly and then rapidly discharged into the piezo. In response to a control signal received by HV circuit 1102, a suitable waveform may be generated and passed through diode 1104 to a bank of piezo discs, structures and/or elements (as depicted as 1108a and 1108b in FIG. 11). It should be appreciated that—while only two piezo structures are shown in FIG. 11—more piezo structures may be driven by this circuit that would be of sufficient number to provide a suitable haptic experience to the user of the device.

As is also shown in FIG. 11, switches A, B, and C may be applied in a suitable sequence—either after or during the HV ramp-up. As will be discussed herein, the application of these switches (e.g., by control signals sent by the computer or a controller, not shown) may affect the desired waveforms across the piezos. In addition, it should be noted that switches A and B may also be driving with Pulse-Width Modulation (PWM) signals, thereby providing control over the waveform slopes—which may be sufficient for adjusting haptic feeling and sound.

For merely one example, a rapid UP signal on piezo A may be implemented in a current-limited system by keeping all switches open and first charging the capacitor, and then closing A. However, in certain height-limited applications, it may not be possible to implement a high voltage capacitor of appropriate capacitance, e.g. 0.1 uF or more.

In such cases, it may be possible to use one of the other piezo banks as a charge storage element. For example, if the circuitry 1100 may close switch B, slowly charge piezo B, then close switch A, simultaneously rapidly discharging B and charging of A. Switch C may then provide a rapid discharge of both piezos. In the cases where a slowly charged piezo B is followed by a rapidly discharged piezo B might result in a DOWN haptic experience for the user, it may be possible to select a piezo B within the bank of piezos that is not in proximity to the user's body (and thereby not induce an inadvertent haptic experience to the user). In addition, it may be advisable to provide sound-dampening material and/or means around piezo B, to prevent (or shape) spurious audio effects.

Alternative Embodiments Employing PMW Schemes

For other alternative embodiments, it may be possible to design a Pulse-Width Modulation (PWM) scheme to drive the charge cycle, and a separate PWM to drive the discharge cycle. Varying heights, varying charge and discharge times, as well as varying the pulse-width schedule of the PWM driving the switcher, are all possible variations to affect different sensations. It will be appreciated that it would be possible to generate any waveform that is desired—e.g., including any combination of the above features.

In one embodiment, during a click event, the piezo may first be charged by generating a PWM that drives a simple FET/inductor/diode boost circuit. The PWM “on” time may be matched to the characteristics of the discrete components—e.g., it may be the time desired to establish max current in the inductor. Leaving the FET turned on any longer may tend to waste power by shunting current to GND longer than suitable. The overall charge time may be controlled by varying the PWM period. The charge time may be controlled to limit the maximum current spikes taken from e.g., the system's battery.

In one embodiment, the charge cycle may be run open-loop—i.e., the PWM may be run for a fixed number of cycles (possibly determined heuristically or by experimentation) to charge the piezo to the desired voltage. However, the relationship between the final piezo voltage and the number of PWM cycles may depend on many variables in the system, including the actual piezo capacitance, the driver source voltage, the FET, diode, and inductor characteristics, etc.

Once the piezo has been charged to 60V, it may be quickly discharged back to the driver idle voltage (e.g., ^{˜}5V). This discharge may be performed by generating another PWM that drives a discharge FET/resistor. The resistor may provide a limit on the discharge rate (e.g., ^{˜}600 uS)—so for a maximum discharge rate, the PWM may not be desired and may just be run wide open (100% duty cycle). Slower discharge rates may then be achieved by adjusting the PWM duty cycle.

As with charging, the discharge cycle may also be run open loop, i.e. it is possible to discharge the piezo for a fixed number of cycles. However, it may be desirable to have a suitable number of cycles. Otherwise, there may be some residual voltage on the piezo, which could build up over repeated actuations and may interfere with accurate pressure sensing.

In many of the embodiments described herein, it is possible to sense the nature of the user's interaction to create a desired haptic experience—e.g., where is the user touching the device, etc. In such a case, it may be possible to employ the piezo structures as sensors. It may be desirable to have an additional circuit that can measure the voltage across the piezo. In one embodiment, it may be desirable to close the loop on the charge and/or discharge cycles. Due to the high voltages used to drive the piezo and the low voltage produced by the piezo when used as a sensor, it may be desirable to have multiple gain modes in the measurement circuit. Switching between the gain modes may be done to ensure voltage limits are not exceeded on sensitive components such as FET amplifier and/or ADC inputs. For example, during discharge it may be desirable to switch the measurement circuit from low gain mode to high gain mode. However, it may be undesirable to do this too early—as the high voltage may damage components in the measurement circuit. Therefore, it may be desirable to discharge first in low gain mode until a piezo voltage is reached that, when switched over to high gain mode, may still be within the operating range of the measurement circuit. It may then be possible to continue to discharge in high gain mode until the desired driver idle voltage is reached.

Depending on the characteristics of the FET, it may be possible that the lowest measureable voltage in low gain mode may still be higher than the highest measureable voltage in high gain mode. In this case, it may be desirable to run the discharge open-loop for several additional PWM cycles before switching to high gain mode.

However, one concern with closing the loop on the piezo discharge may be that the time constant of the measurement circuit may not be insignificant compared to the total piezo discharge time. Therefore, by the time the system senses that the piezo voltage is as desired, it may have already been discharged beyond that point.

Thus, it may be desirable to anticipate this and terminate the discharge cycle when the sensed voltage is somewhat above a desired target. For example, this voltage offset may be designed so there may be a slight residual voltage on the piezo left over. This would tend to avoid wasting power by turning on the driver diode during discharge. This offset may not accumulate over repeated actuations because the system may discharge to the substantially same voltage after each actuation. The residual voltage may slowly discharge to the driver idle voltage (e.g., via leakage in the measurement circuit and piezo). In one embodiment, the pressure sensing algorithm may be designed to allow the baseline to track downward as the piezo voltage drifts down.

In another embodiment, closed-loop discharge may be affected a long settling time of the mechanical system after a discharge. Thus, even after the system has stopped discharging, the piezo voltage may continue to change while the mechanical system (piezo, adhesive, glass, finger, etc.) settles to its final steady state condition. In one embodiment, the time constant of this mechanical system (30-50 ms) may be long compared to the total discharge time (<1 ms). Typically the piezo voltage may increase after discharge is stopped. If the system attempted to resume sensing piezo pressure soon after the end of the discharge cycle, the system may see the piezo voltage rising fast enough and far enough to indicate increasing finger pressure on the piezo.

Thus, it may be desirable that, after each haptics event (charge followed by discharge), the controller may enter a special haptics recovery mode. In this mode, pressure sensing may be suspended and the piezo voltage is discharged approximately every 10 ms until a specified settling time (35 ms) has expired. At the end of this settling time, it may be the case that the mechanical system is sufficiently settled and pressure sensing is resumed.

Piezo Driving Circuit Embodiments

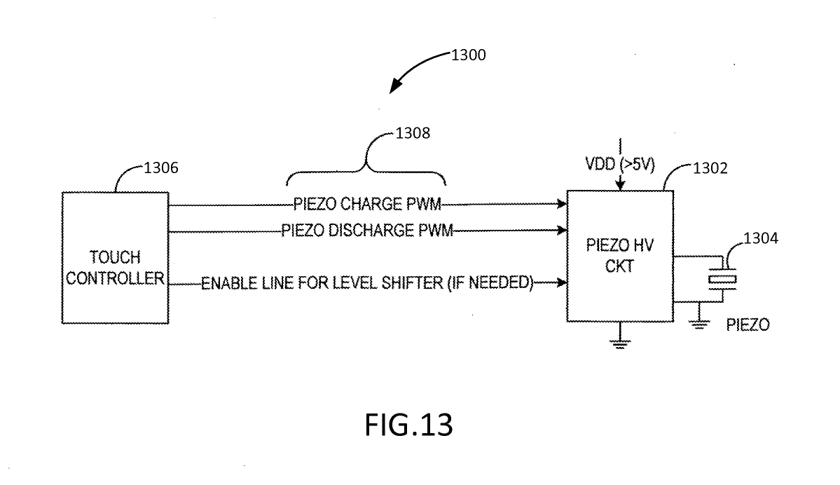

FIG. 12 is one possible embodiment of a piezo driving circuit for a suitable piezo structure, as disclosed herein. As may be seen, V1 is a voltage source (e.g., a battery voltage). C4 stores charge, thus limiting the size of current spikes. Inductors L1/L2, diode D1, and FET M1 form the switching components. V2 represents a PWM output from the piezo controller for the charge cycle, possibly after going through a level shifter to bump the voltage up to a desired level (e.g., 5V) to turn the FET on harder. V3 represents a PWM output from the piezo controller for the discharge cycle. FET M2 performs the discharge. It will be appreciated that, while FIG. 12 contains exemplary values for several of the components therein, the scope of the present application should not be limited by these exemplary values. Other circuits and values are possible and the present application encompasses their scope.

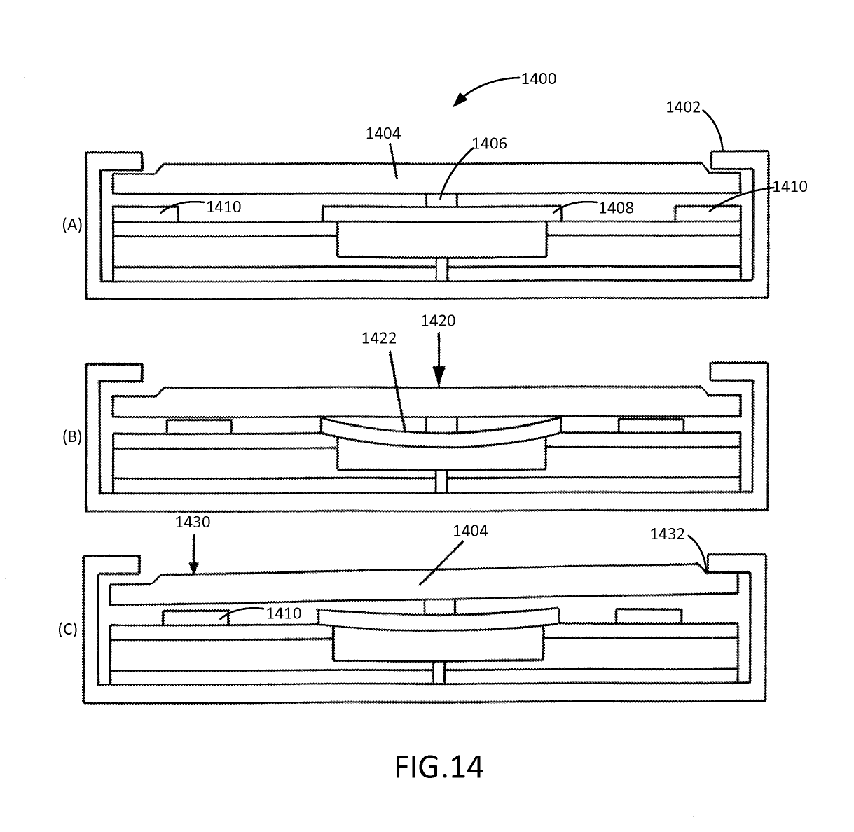

FIG. 13 is one embodiment (1300) of a piezo controller 1306 in communication with a piezo drive circuit 1302 and piezo element 1304. Piezo controller 1306 may supply drive and/or control signals (1308) to piezo circuit 802—e.g., piezo charge PWM signal, piezo discharge PWM signal, enable line for level shifter (if needed). Optionally, piezo drive circuit may send back the piezo voltage for ADC signal, as desired (not shown).

Alternative Switch Embodiments

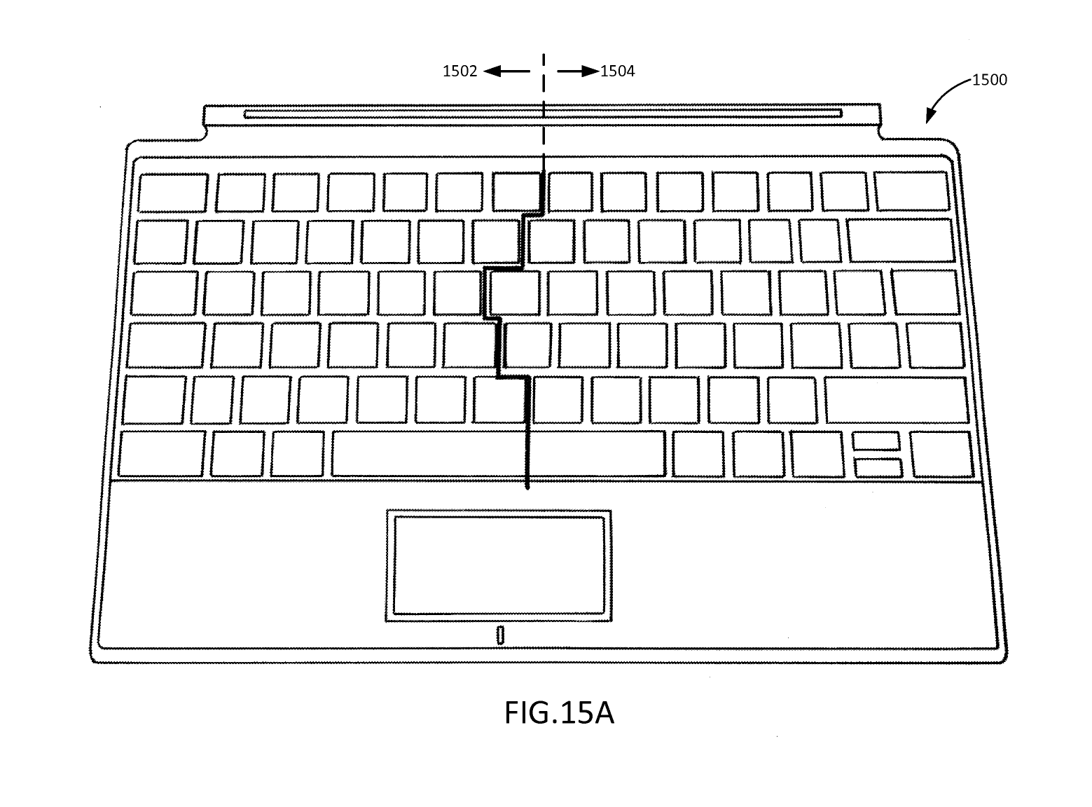

For a first alternative embodiment, it may be possible to use a piezo structure as depicted in FIGS. 14A, 14B and 14C. Piezo structure 1400 may comprise a housing 1402 that provides a substantially rigid structure, e.g., for a structure that emulates a physical switch. With housing 1402, a floating level 1404 may, as at rest in FIG. 14A, may be floating above a piezo layer 1408, by resting on layer 1408 via a push bar 1406. Floating bar 1404 may be many possible structures—for example, e.g., a 2-dimensional plate that provides a touch surface that couples the haptic displacement to user's finger(s) that touch the plate. In other embodiments, floating bar 1404 may be a bar or disc structure, or other structure as desired. In one embodiment, push bar 1406 may be a plunger (of cylindrical or other suitable shape) that may transmit the deflection of piezo structure 1408 to 1404.

In FIG. 14B, a force (e.g., supplied via the depression by a user's figure, stylus or other I/O device) may induce the floating bar 1404 to deform the piezo structure 1408; and thereby sending a suitable signal in response. In one embodiment, a cavity may be underneath piezo structure 1408 that may allow the center of structure 1408 to deflect, e.g., vertically and freely—while structure 1408 may be supported by its contour edges. In one embodiment, protective stops 1410 may be a ring structure—or some other suitable structure in other embodiments. Stops 1410 may be placed to prevent a certain displacement. These stops may be optional if a strong push may not break the piezo, e.g., if the maximum deflection is limited by the dimensioning of the plunger and the piezo structure as designed.

In FIG. 14C, it may be seen that a light touch that is off-center (as depicted 1430) may cause the floating bar 1404 to gimbal to one side of the housing and a portion (1432) of the floating bar 1432 to be touching with the top of the housing—e.g., forming a cantilever. This may tend to make an efficient coupling of the deflection created by the piezo disc to be coupled to the touching finger (1430). In some cases, the more the touch point is away from the center, the more vertical movement may tend to be received by the finger up to 2× of the displacement at the center. However, the vertical displacement may be on the order of tens of micrometers, a typical user may not notice the difference.

For this and other switch embodiments, the piezo structure may be mated to a deformable layer by any of the following: adhesive, pusher structure, support structures and mounting structures.

Alternative Embodiments Comprising Isolated Haptic Regions

Now, there will be described various embodiments devices having haptic feedback that may comprise regions, partitions and/or zones of substantially isolated haptic user experiences. In many of these embodiments, there may be regions formed by appropriate placement of piezo discs, structures and/or elements that are meant to provide a desired haptic experience to the user of the device. These regions may be isolated—e.g., by appropriate placement of backer structures (and/or other vibration dampening material) that may block haptic sensations from one region into another region.

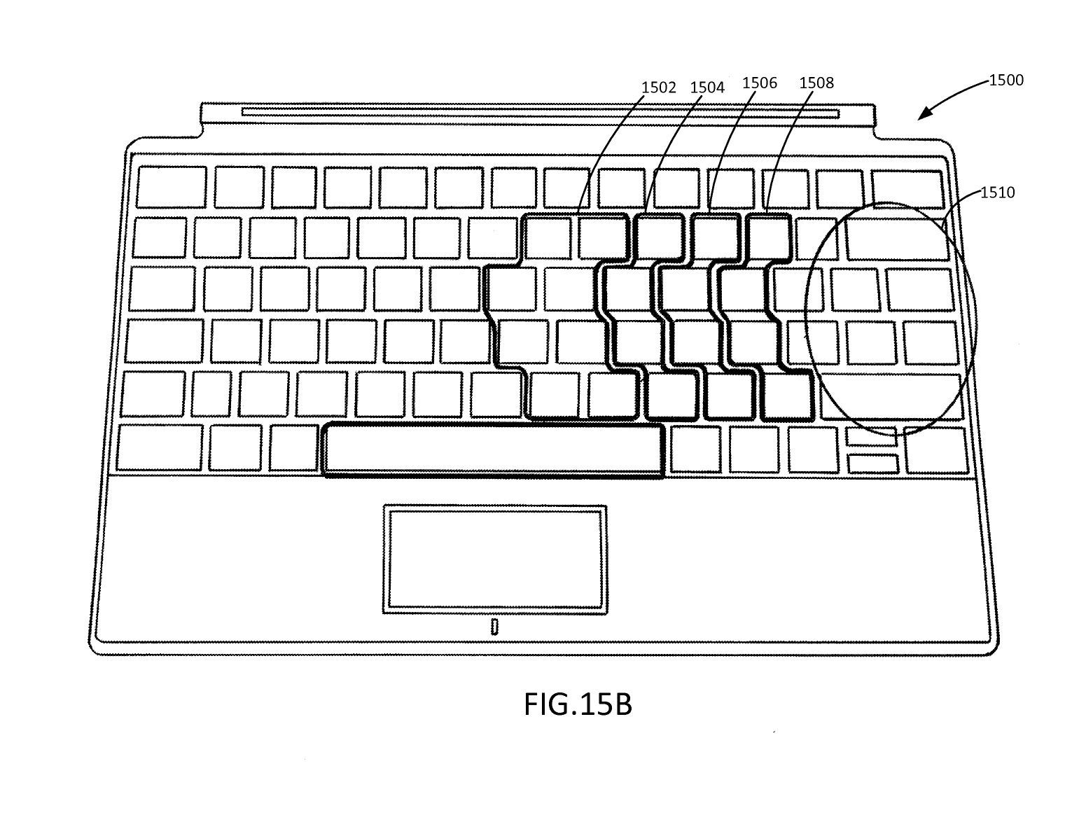

FIG. 15A is merely one exemplary embodiment of a keyboard 1500 that may be constructed with two substantially isolated haptic regions—i.e., a left hand region 1502 and a right hand region 1504 of the keyboard. In this embodiment, haptic experiences of the right hand and the left hand would tend to be substantially isolated from one another—thus, giving a better haptic experience to the user.

FIG. 15B is another exemplary embodiment of a keyboard 1500 that is divided or otherwise partitioned into substantially isolated haptic regions 1502, 1504, 1506, 1508 and 1510—e.g. for the right hand. This partitioning may be useful in order to tend to isolate the haptic experience to the user's right hand fingers. A similar partition may be possible for the fingers left hand of the user.

It will be appreciated that there are a variety of partitions that may be suitable and/or desirable to implement on the surface of a touch/haptic enabled device. It may suffice for purposes of the present application that substantially isolated regions of the device provide an improved haptic experience to the user. Firing haptics in separate regions tends to enhance the perception of localized actuations.

In operation, for multi-area user interfaces, like trackpads, keyboards, or screens, haptics may be fired across the whole surface (e.g., using single or multiple actuators). Alternatively, haptics may be fired in regions using single or grouped actuators. It should be noted that haptics may still be desirable to fire multiple regions simultaneously, for example to produce audio effects or some other meaningful global haptic effect.

In many of these embodiments, devices that may affect firing in different regions may help reduce electronics costs and power requirements since electrical loading may be reduced. For example, for the circuit (as shown in FIG. 13), there may be multiple HV circuits (e.g. 1302) that drive individual regions under control from controller 1306.

In one exemplary embodiment of a keyboard, it may be desired to construct a keyset haptic feedback, such that there is a single haptic event and/or response (*click*) on the keystroke downstroke, and possibly no haptic feedback on release. For trackpad button feedback, it may be desirable to apply a haptic event/response (*click*) on downstroke, and another upstroke haptic event/response as the user's finger starts to release. In this way, the device may emulate a dome switch feeling.

In these various embodiments, the circuitry to produce these waveforms may be created in a variety of techniques known to the art. It may be desirable to avoid high frequency ringing, as such ringing may create unwanted audible effects.

In some embodiment, it may be desirable to temporarily hold-off the capsense and/or pressure sensing systems at the moment of firing the haptics, to avoid noise coupling.

Audio Haptic Embodiments

In many conventional haptic-enabled devices, haptics are generally audible in nature—and may be configured, e.g., as speakers. In many of the embodiments disclosed herein, it may be desirable to configure haptics as tactile feedback in some interactions, and as audio feedback in others. For merely one example, it may be possible to construct a keyboard (e.g., 104)—such that there is haptic feedback in the trackpad for button clicks, but may be re-configured to produced audio feedback clicks when the user strikes keys in the keyset. In such embodiments, it may be possible to send out different waveforms—e.g., one tailored for sound, and another for feel.

Embodiments of Haptics in Displays

In many embodiments, it is possible to construct piezos with sufficient strength to warp glass and produce a haptic effect. However, piezos tend to be opaque. Thus, in one embodiment, the piezos may be placed behind the emissive or reflective elements of the display.

In many embodiments, it is possible to construct displays with various flatscreen technologies that may be compatible with such assemblies: e.g. OLED or other thick-film LED display, where the emissive elements are laid, screen-printed, patterned, or otherwise grown on the glass. In many embodiments, piezo components may be mounted behind these emissive elements.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A piezo-actuated structure, said structure comprising:
a non-traveling deformable layer;
a piezo layer, said piezo layer mechanically mated to said deformable layer;
a backer structure, said backer structure mechanically mated to said deformable layer and further wherein said
a set of user sensors; and
further wherein said piezo layer is capable of transmitting a haptic response to said deformable layer in response to a user interaction sensed by said set of user sensors.

2. The piezo-actuated structure of claim 1 wherein said piezo layer comprises one of a group, said group comprising: piezoceramic material, PZT, electroactive polymers and electromechanical polymers.

3. The piezo-actuated structure of claim 1 wherein said deformable layer comprises one of a group, said group comprising: PCB, glass, gorilla glass and plastic.

4. The piezo-actuated structure of claim 1 wherein said piezo layer is mechanically mated to said deformable layer by one of a group, said group comprising: adhesive, solder, solder paste, pusher structure, support structures and mounting structures.

5. The piezo-actuated structure of claim 1 wherein said structure further comprises:
a pusher structure, said pusher structure mechanically mated to said deformable layer and further said pusher structure capable of providing mechanically communication between said deformable layer and said piezo layer; and
support structures, said support structures mechanically mated to said piezo structure and further capable of supporting said piezo layer.

6. The piezo-actuated structure of claim 1 wherein said non-traveling deformable layer comprises a printed circuit board and said piezo layer comprises a set of piezo structures; and
wherein said set of piezo structures are mated to said printed circuit board.

7. The piezo-actuated structure of claim 6 wherein said set of piezo structures comprise a set of substantially isolated haptic regions upon said printed circuit board.

8. The piezo-actuated structure of claim 7 wherein said backer structure forms said set of substantially isolated haptic regions.

9. The piezo-actuated structure of claim 7 wherein said set of substantially isolated haptic regions comprises a set of desired haptic user experiences when said piezo layer is actuated.

10. The piezo-actuated structure of claim 9 wherein said set of desired haptic user experiences comprises a group, said group comprising: one hand haptic experience, right hand haptic experience, left hand haptic experience, user finger haptic experience and a tactile response in conjunction with an audio response.

11. The piezo-actuated structure of claim 1 wherein said haptic response comprises one of a group, said group comprising: a click response, a dome switch response, downstroke haptic response, and audio response and an upstroke haptic response.

12. The piezo-actuated structure of claim 11 wherein said piezo layer is capable of being activated by a first electric waveform; and
wherein said first electric waveform comprises one of a group, said group comprising: a first fast charging portion and a second slow discharging portion, a first slow charging portion and a second fast discharging portion, a first fast charging portion and plateau and a second fast discharging portion.

13. A method for actuating a piezo-actuated structure, said piezo-actuated structure comprising a non-traveling deformable layer, a backer structure mated to said deformable layer and forming a set of substantially isolated haptic regions upon said deformable layer, a set of piezo elements mated to said deformable layer and placed within said set of substantially isolated haptic regions, a set of user sensors and controller for receiving signals from said set of user sensors and sending control signals to said set of piezo elements in response to said signals, the method comprising:
receiving a first signal from said set of user sensors in response to a user interaction;
determining which isolated haptic region said user is interacting; and
sending an actuation signal to at least one piezo element within said isolated haptic region said user is interacting.

14. The method of claim 13 wherein said piezo-actuated structure is a one of a group, said group comprising: a keyboard, a trackpad and a touch display; and
wherein the step of sending an actuation signal further comprises providing an isolated haptic experience to the user within said isolated haptic region.

15. The method of claim 14 wherein providing an isolated haptic experience to the user comprises one of a group, said group comprising: one hand haptic experience, right hand haptic experience, left hand haptic experience and user finger haptic experience.

16. The method of claim 15 wherein said isolated haptic experience comprises one of a group, said group comprising: a click response, a dome switch response, downstroke haptic response, an audio response and an upstroke haptic response.

17. The method of claim 16 wherein sending an actuating waveform further comprises one of a group, said group comprising: a first fast charging portion and a second slow discharging portion, a first slow charging portion and a second fast discharging portion, a first fast charging portion and plateau and a second fast discharging portion.

18. A haptic-enabled device comprising:
a touch sensitive surface, said touch sensitive surface further comprising a deformable layer;
a backer structure, said backer structure partitioning said deformable layer into a set of isolated haptic regions;
a set of piezo elements, said set of piezo elements in mechanical communication with said deformable layer and placed with said set of isolated haptic regions;
a set of user sensors, said set of user sensors capable of sensing a user interaction with said touch sensitive surface;
a controller, said controller capable of receiving signals from said set of user sensors and sending control signals in response to receiving signals from said set of user sensors; and
a piezo actuating circuit, said piezo actuating circuit capable of receiving control signals from said controller and sending piezo-actuating signals to said set of piezo elements.

19. The haptic-enabled device of claim 18 wherein said set of piezo elements are capable of providing a set of isolated haptic events to a user in response to a user interacting with said device at one of said isolated haptic regions.

20. The haptic-enabled device of claim 19 wherein said haptic-enabled device comprises one of a group, said group comprising: a smart phone, a smart device, a keyboard, a trackpad, a touch sensitive screen.
